(19) United States
(12) Patent Application Publication
(10) Pub. No.: US 2014/0161703 A1
(43) Pub. Date: Jun. 12, 2014

(54) PROCESS FOR PRODUCTION OF SODIUM BOROHYDRIDE and diphenyl oxide

(71) Applicants: Paul R. Elowe, Midland, MI (US); David C. Molzahn, Midland, MI (US)

(72) Inventors: Paul R. Elowe, Midland, MI (US); David C. Molzahn, Midland, MI (US)

(21) Appl. No.: 14/232,627

(22) PCT Filed: Jul. 18, 2012
(86) PCT No.: PCT/US2012/047128

§ 371 Date: Jan. 14, 2014

Related U.S. Application Data
(60) Provisional application No. 61/511,203, filed on Jul. 25, 2011.

(51) Int. Cl. C01B 6/21

(52) U.S. Cl. CPC C01B 6/21
USPC 423/288

(57) ABSTRACT

A process for production of an alkali metal borohydride. The process comprises three steps. The first step is combining a phenyl ester of a boric acid ester precursor with a compound of formula MAlH_{4-31 x}(OPh)ₓ, where x is from zero to three, M is an alkali metal and Ph is phenyl; to produce an alkali metal borohydride and Al(OPh)₃. The second step is separating sodium borohydride from Al(OPh)₃. The third step is heating Al(OPh)₃ to produce diphenyl oxide.

### BACKGROUND

This invention relates generally to a process for production of sodium borohydride and diphenyl oxide.

Production of sodium borohydride from the reaction of sodium aluminum hydride with a boric acid ester with conversion of byproduct aluminum alkoxides to aluminum sulfate and recycle of alcohol is disclosed in U.S. Pat. No. 7,247,286.

The problem addressed by this invention is to find a more efficient and economical process for production of sodium borohydride from sodium aluminum hydride that extracts additional value from the byproducts.

### STATEMENT OF INVENTION

The present invention is directed to a process for production of an alkali metal borohydride. The process comprises steps of: (a) combining a phenyl ester of a boric acid ester precursor with a compound of formula MAlH₄₋ₓ(OPh)ₓ, where x is from zero to three, M is an alkali metal and Ph is phenyl; to produce an alkali metal borohydride and Al(OPh)₃; (b) separating sodium borohydride from Al(OPh)₃; and (c) heating Al(OPh)₃ to produce diphenyl oxide.

### DETAILED DESCRIPTION

All percentages are weight percentages (wt %), and all temperatures are in ° C., unless specified otherwise. A “boric acid ester precursor” is a compound containing boron and oxygen, e.g., B(OH)₃, which can be converted into a boric acid phenyl ester, e.g., B(OPh)₃. Preferably, a boric acid ester precursor is an acid or salt containing a BO₃⁻³, B₄O₇⁻² or BO₂⁻¹ group. Boric acid esters include boroxine compounds, e.g., (PhOBO)₃, typically formed at higher temperatures and 1:1 stoichiometry between the boric acid ester precursor and phenol. Preferably, the reaction temperature is from 100° C. to 300° C., preferably from 110° C. to 250° C., preferably from 110° C. to 200° C.,. Examples of the conversion of a boric acid ester precursor to a boric acid ester include but are not limited to the following examples:

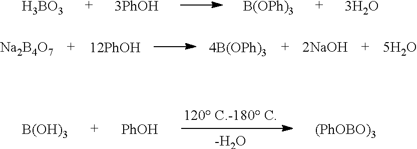

Preferably, M is lithium, sodium or potassium; preferably lithium or sodium; preferably sodium. MAlH₄₋ₓ(OPh)ₓ may be a mixture of compounds each of which has an integer value of x from zero to four, in which case x refers to the molar average value of x for the mixture. Preferably, x is from zero to two.

An alkali aluminum hydride may be produced from its constituent elements at high temperatures, e.g., according to the following equation, in which M is Na.

Na+Al+2H₂→NaAlH₄

For example, U.S. Pat. No. 4,081,524 discloses preparation of sodium aluminum hydride in hydrocarbon solvents at 160° C. and a pressure of 5000 psi (34,000 kPa). Compounds of formula MAlH₄₋ₓ(OPh)ₓ, where x is from one to three, or mixtures of compounds having an average value of x from one to three, may be produced by combining a compound of formula (PhO)M with aluminum and hydrogen, as described, e.g., in U.S. Pat. No. 3,728,272.

Preferred solvents for the reaction of a phenyl ester of a boric acid ester precursor with a compound of formula MAlH₄₋ₓ(OPh)ₓ are those in which the sodium borohydride has limited solubility, e.g., ethers, including 2-methyl-tetrahydrofuran, tetrahydrofuran, dimethoxyethane, diglyme, triglyme, tetraglyme, diethyl ether, dibutyl ether and dibutyl diglyme; aromatic solvents; and alkanes. Especially preferred solvents include 2-methyl-tetrahydrofuran, tetrahydrofuran and dimethoxyethane. Preferably, this reaction proceeds at a temperature in the range from 0° C. to 50° C., preferably from 10° C. to 35° C. Preferably, the sodium borohydride precipitates from the reaction solvent and is separated, while the aryloxide salts remain in solution.

The reaction may also be run without a solvent, e.g., as a slurry process or by grinding the solid reactants. Grinding of the reactants will accelerate the reaction, and may be achieved using any method which applies energy to solid particles to induce a mechanochemical reaction, especially any method which reduces solids to the micron size range, preferably the sub-micron size range, and continually exposes fresh surfaces for reaction, e.g., impact, jet or attrition milling. Preferred methods include ball milling, vibratory (including ultrasonic) milling, air classifying milling, universal/pin milling, jet (including spiral and fluidized jet) milling, rotor milling, pearl milling. Especially preferred methods are planetary ball milling, centrifugal ball milling, and similar types of high kinetic energy rotary ball milling. Preferably, milling is performed in either a hydrogen atmosphere, or an inert atmosphere, e.g., nitrogen. In an embodiment in which a solvent is used, grinding of the reactants may be achieved using any method suitable for grinding a slurry. A solvent facilitates heat transfer, thereby minimizing hot spots and allowing better temperature control. Recycle of the solvent is possible to improve process economics. Examples of solvents suitable for use during the process include amines, especially tertiary amines; alkanes and cycloalkanes, especially C₈-C₁₂ alkanes and cycloalkanes; ionic liquids; liquid crown ethers; and for lower-temperature reaction conditions, toluene, glymes and ethers. Suitable reaction solvents are those in which the borohydride compound is soluble and which are relatively unreactive with borohydride.

Another method to accelerate the reaction is to use radiation techniques alone or in combination with reactive milling. For example, microwave irradiation can direct energy at specific reaction surfaces to provide rapid heating and deep energy penetration of the reactants. Microwave absorbers such as metal powders, which could be used as milling media, and dipolar organic liquids may also be added to the reaction system to promote the reaction. The advantage of these techniques is that high reaction rates may occur at considerably lower processing temperature than could be obtained with resistive heating thermal techniques.

Preferably, the sodium borohydride and the Al(OPh)₃ product are separated by dissolving the aluminum product in a suitable solvent in which the sodium borohydride is substantially insoluble. Preferably the solvent is a hydrocarbon solvent. Preferably, a solvent may be used to separate the borohydride product from the aluminum phenoxide. Suitable solvents are those in which the borohydride compound is soluble and which are relatively unreactive with borohydride. A solvent in which the borohydride compound is soluble is one in which the borohydride compound is soluble at 25° C. at least at the level of 2%, preferably, at least 5%. Preferred solvents include liquid ammonia, alkyl amines (primary and secondary), heterocyclic amines, alkanolamines, alkylene diamines, glycol ethers, amide solvents (e.g., heterocyclic amides and aliphatic amides), dimethyl sulfoxide and combinations thereof. Preferably, the solvent is substantially free of water, e.g., it has a water content less than 0.5%, more preferably less than 0.2%, more preferably less than 0.1%. Especially preferred solvents include ammonia, C₁-C₄ mono-alkyl amines, pyridine, 1-methyl-2-pyrrolidone, 2-aminoethanol, ethylene diamine, ethylene glycol dimethyl ether, diethylene glycol dimethyl ether, triethylene glycol dimethyl ether, tetraethylene glycol dimethyl ether, dimethylformamide, dimethylacetamide, dimethylsulfoxide and combinations thereof.

The Al(OPh)₃ is heated to produce diphenyl oxide and alumina, as shown in the following equation.

2Al(OPh)₃→Al₂O₃+3PhOPh

Diphenyl oxide, PhOPh, is a useful product having commercial value; preferably it is sold to increase the overall economic efficiency of the process. Preferably, aluminum phenoxide is heated to a temperature from 200-500° C., preferably 300-400° C., as described in U.S. Pat. No. 4,360,699.

1. A process for production of an alkali metal borohydride; said process comprising steps of: (a) combining a phenyl ester of a boric acid ester precursor with a compound of formula MAlH₄₋ₓ(OPh)ₓ, where x is from zero to three, M is an alkali metal and Ph is phenyl; to produce an alkali metal borohydride and Al(OPh)₃; (b) separating sodium borohydride from Al(OPh)₃; and (c) heating Al(OPh)₃ to produce diphenyl oxide.

2. The process of claim 1 in which M is lithium, sodium or potassium.

3. The process of claim 2 in which the phenyl ester of a boric acid ester precursor and the compound of formula MAlH₄₋ₓ(OPh)ₓ are combined in a hydrocarbon solvent.

4. The process of claim 3 in which x is zero.

5. The process of claim 4 in which M is sodium

6. The process of claim 2 in which x is from zero to two.

7. The process of claim 6 in which M is sodium.

8. The process of claim 7 in which the phenyl ester of a boric acid ester precursor and the compound of formula MAlH₄₋ₓ(OPh)ₓ are combined in a hydrocarbon solvent.

9. The process of claim 8 in which x is from one to two.
